(19) United States
(12) Patent Application Publication
(10) Pub. No.: US 2018/0073800 A1
(43) Pub. Date: Mar. 15, 2018

(54) REFRIGERATOR

(71) Applicant: Panasonic Corporation, Osaka (JP)

(72) Inventors: TORU OKAZAKI, Osaka (JP); YASUHIRO ASAIDA, Kyoto (JP); TERUTSUGU SEGAWA, Osaka (JP); BAIYU LIU, Osaka (JP)

(21) Appl. No.: 15/685,775

(22) Filed: Aug. 24, 2017

(30) Foreign Application Priority Data
Sep. 9, 2016 (JP) 2016-176086
May 25, 2017 (JP) 2017-103641

(51) Int. Cl. F25D 23/08

(52) U.S. Cl. CPC F25D 23/087; E05C 19/161

(57) ABSTRACT

A refrigerator suppresses heat penetration into a chamber of the refrigerator from the outside through an open part. The refrigerator, includes: a heat-insulation box that has an open part, and a double structure including an outer box and an Inner box; a door that is engaged with the heat-insulation box; and a gasket that is located between the heat-insulation box and the door, wherein inner-box/outer-box-joint regions of the outer box and the inner box are located to an outer side of the heat-insulation box, and are located outward beyond door/heat-insulation-box-joint regions of the door and the heat-insulation box that are joined with each other.

### TECHNICAL FIELD

The technical field relates to a structure of a heat-insulation box for refrigerators.

### BACKGROUND

Conventional refrigerators are formed of heat-insulation boxes and doors. Front open parts of the heat-insulation boxes have a structure in which outer boxes made of metal materials (e.g., iron plates) and resin-made inner boxes are engaged with each other, and in which foam heat-insulation materials are filled into gaps between the outer boxes and the inner boxes.

FIG. 8 is an elevation view of a conventional refrigerator disclosed in JP-A-2011-237116, and FIG. 9 is an enlarged sectional view of a joint part between a door and a main body of the conventional refrigerator.

As shown in FIG. 8, the refrigerator 1 is provided with a heat-insulation box 10, a pivoting-type refrigeration-compartment door 20 that is located at a front open part of the heat-insulation box 10, drawer-type freezer-compartment doors 52a, 52b and 52c, and a drawer-type vegetable-compartment door 55. These doors have the same basic structure except for dimensions. The joint part between the door 20 and the main body of the refrigerator 1 will now be described with reference to FIG. 9.

The heat-insulation box 10 is configured in such a manner that a heat-insulation material 9 is filled into a gap between an outer box 11 made of a metal material (e.g., iron plates), and an inner box 12 made of a resin (e.g., ABS resins) by way of foaming.

The door 20 is provided with a folded part 31 that comes into contact with a magnet gasket 90, and a folded part 32 (called a second flange) that comes to engage with the inner box 12.

The door 20 is configured in such a manner that a heat-insulation material 9 is filled into a gap between an outer door plate 21 and an inner door plate 22 that is formed of a ABS or PS resin, based on foaming. Additionally, the magnet gasket 90 is inserted into the inner door plate 22.

The magnet gasket 90 is configured by a magnet chamber 93 and a pocket part 94, and a magnet 92 is embedded in the magnet chamber 93.

When the refrigeration-compartment door 20 is closed, the magnet 92 in the magnet gasket 90 adheres to the folded part 31 of the front side of the outer box in the heat-insulation box 10. Thus, the magnet 92 forms a sealed structure, together with the heat-insulation box 10, to thereby prevent heat penetration from the outside of the refrigerator (leakage of the cold air).

Furthermore, FIG. 10 is an enlarged sectional view of an area around an open part of a refrigerator that includes a conventional open part disclosed in JP-A-2013-185713.

A heat-insulation box 10 is configured in such a manner that a heat-insulation material 9 is filled into a gap between an outer box 41 made of a metal material (e.g., an iron plate), and an inner box 42 made of a resin (e.g., ABS). No folded structure is found in a front side of the outer box in the front open part of the refrigerator, and the outer box 41 and the inner box 42 are joined at a flat part 41a of the outer box 41 and a flat part 42a of the inner box 42 via an anchoring member 105.

No differences are found between the structures of the doors 20 described in JP-A-2011-237116. Thus, when the chiller-compartment door 20 is closed, a magnet (not shown in the figure) in a magnet gasket 90 adheres to the flat part 41a of the outer box in the heat-insulation box 10, and thus, forms a sealed structure, together with the heat-insulation box 10, to thereby prevent heat penetration from the outside of the refrigerator (leakage of the cold air).

### SUMMARY

However, based on the above-mentioned conventional open part disclosed in JP-A-2011-237116 (depicted in FIGS. 8 and 9 in this application), it is impossible to sufficiently prevent heat penetration. The part of the metal-made outer box 11 that comes to adhere to the magnet gasket 90, i.e., the first flange part (folded part 31), is exposed on a low-temperature-zone interior area of the chamber, and thus, heat would penetrate into the interior area of the chamber from the outside along a path referred to by “A” in FIG. 9. Furthermore, the metal-made second flange part (folded part 32) is also configured to come close to the low-temperature-zone interior area of the chamber, and thus, heat would penetrate into the inside of the chamber from the outside through the heat-insulation material 9 and the inner box 12 along a path referred to by “B” in FIG. 9.

Furthermore, since the above-mentioned conventional open part disclosed in JP-A-2013-185713 (depicted in FIG. 10 in this application) does not have any flange parts as found in JP-A-2011-237116, any heat would not penetrate into the chamber through folded parts. However, the part of the metal-made outer box 11 that comes to adhere to the magnet gasket 30, i.e., the flat part 41a of the outer box 41, is exposed on the low-temperature-zone interior area of the chamber, and thus, heat would penetrate into the inside of the chamber along a path referred to by “A” in FIG. 10, in the same manner as the case of JP-A-2011-237116. In both of the cases of JP-A-2011-237116 and JP-A-2013-185713, the metal materials that form the outer boxes, which have high heat conductance, are exposed on the inside areas of the chambers, at the adhering parts of the magnets 92 of the magnet gaskets 90.

The disclosure solves the above-described problems in the conventional arts, and thus, an object of the disclosure is to provide a heat-insulation box that makes it possible to reduce amounts of heat penetration through open parts of refrigerators, thereby improving heat-insulation performance of refrigerators.

To solve the above object, provided is a refrigerator, including: a heat-insulation box that has an open part, and a double structure including an outer box and an inner box; a door that is engaged with the heat-insulation box; and a gasket that is located between the heat-insulation box and the door, wherein inner-box/outer-box-joint regions of the outer box and the inner box are located to an outer side of the heat-insulation box, and are located outward beyond door/heat-insulation-box-joint regions of the door and the heat-insulation box that are joined with each other.

According to the disclosure, it becomes possible to improve heat-insulation performance of open parts of heat-insulation boxes, and to thus reduce amounts of heat penetration through front parts of the outer boxes, from which large amounts of outside heat often penetrate into the heat-insulation boxes in the conventional arts. Accordingly, it becomes possible to improve temperature-maintenance/refrigerating effects, and thus, the disclosure can provide refrigerators having high heat-insulation performance.

### BRIEF DESCRIPTION OF THE DRAWINGS

FIG. 1 is an enlarged sectional view of an area around an open part of a heat-insulation box according to a first embodiment.

FIG. 2A is a perspective view that shows a structure of an outer box in the heat-insulation box according to the first embodiment.

FIG. 2B is a perspective view that shows an inner box in the heat-insulation box according to the first embodiment.

FIG. 3 illustrates (a) a perspective view that shows a combination of the inner box and a magnetic material in the first embodiment, and (b) a partially-enlarged sectional view of the combination shown in (a).

FIG. 4 illustrates (a) a perspective view of the heat-insulation box according to the first embodiment, (b) a cross-section view that shows engagement of a slot part and a projection part in a combination of the outer box and the inner box in the heat-insulation box according to the first embodiment, and (c) a cross-section view that shows engagement of a hole-less part and a projection-less part in the combination of the outer box and the inner box in the heat-insulation box according to the first embodiment.

FIG. 5 illustrates (a) a perspective view of the heat-insulation box according to the first embodiment, (b) a view that shows engagement of a slot part and a projection part in a structure that is configured by an engagement part between the outer box and the inner box, and a partition plate in the heat-insulation box according the first embodiment, and (c) a view that shows engagement of a hole-less part and a projection-less part in a structure that is configured by an engagement part between the outer box and the inner box, and a partition plate in the heat-insulation box according the first embodiment.

FIG. 6 is an enlarged sectional view of an area around an open part of a heat-insulation box according to a second embodiment.

FIG. 7 is an enlarged sectional view of an area around an open part of a heat-insulation box according to a third embodiment.

FIG. 8 is a view that shows the conventional refrigerator disclosed in JP-A-2011-237116.

FIG. 9 is a view that shows an area around the open part of the conventional refrigerator disclosed in JP-A-2011-237116.

FIG. 10 is a view that shows an area around the open part of the conventional refrigerator disclosed in JP-A-2013-185713.

### DESCRIPTION OF EMBODIMENTS

Hereinafter, embodiments will be described with reference to the drawings.

### First Embodiment

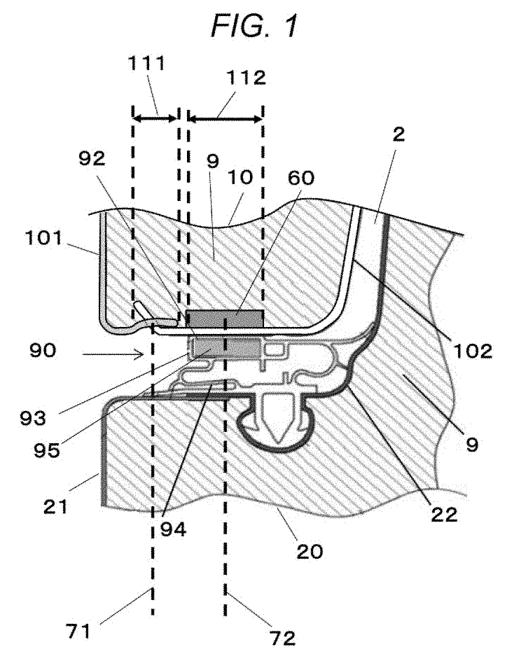

FIG. 1 is an enlarged sectional view of an area around a junction part between a door and a heat-insulation box in a refrigerator. The door is combined with an open part of a heat-insulation box.

### <Structure of the Refrigerator 1>

In FIG. 1, the heat-insulation box 10 in the refrigerator 1 is configured in such a manner that a heat-insulation material 9 is filled into a gap between an outer box 101 that is made of a metal material (e.g., iron plates), and an inner box 102 that is made of a resin (e.g., ABS resins) by way of foaming. An edge of the outer box 101 is provided with an inner-box/outer-box-joint region 111 that binds to the inner box 102. In the same manner, the inner box 102 is provided with a door/heat-insulation-box-joint region 112.

The inner-box/outer-box-joint region 111 is a region where the inner box 102 and the outer box 101 are joined. In this case, the inner-box/outer-box-joint region 111 is a region where the inner box 102 and the outer box 101 overlap with each other. The door/heat-insulation-box-joint region 112 is a region where the door 20 and the heat-insulation box 10 are joined, and, in this case, is a region where a magnet chamber 93 and a magnetic material 60 overlap with each other.

### <Configurations of the Outer Box 101 and the Inner Box 102>

The outer box 101 has the inner-box/outer-box-joint region 111, which is configured by entirely folding an outer lateral surface of the heat-insulation box 10. The inner-box/outer-box-joint region 111 forms an open face of an open part 2 of the front side of the refrigerator 1.

The inner box 102 is formed by way of vacuum molding, and has the folded door/heat-insulation-box-joint region 112, and the folded inner-box/outer-box-joint region 111.

### <Structure of the Inner Box 102>

On the back surface of the inner box 102 (the side adjacent to the heat-insulation material 9), a magnetic material 60 is placed in a position where a magnet 92 in a magnet gasket 90 is opposed to the magnetic material 60 when the door 20 is closed, with an adhesive member (not shown in the figures) that may be formed of an adhesive or double-faced adhesive tape.

### <Positions and Structures of the Inner-Box/Outer-Box-Joint Region 111 and the Door/Heat-Insulation-Box-Joint Region 112>

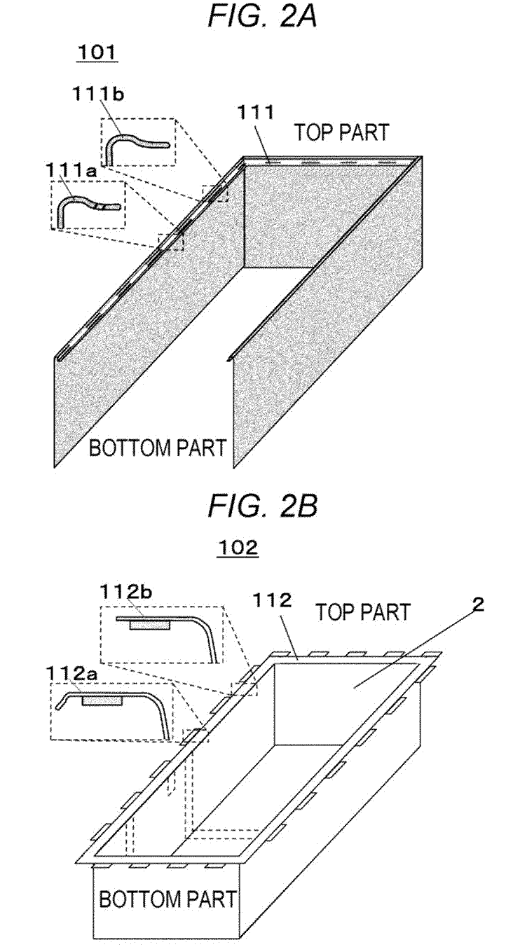

FIG. 2A shows a structure of the outer box 101 in the heat-insulation box according to the first embodiment. In the inner-box/outer-box-joint region 111 of the outer box 101, hole parts 111a each having a slot, and hole-less parts 111b are alternately provided.

FIG. 2B shows a structure of the inner box 102 in the heat-insulation box according the first embodiment. In the door/heat-insulation-box-joint region 112 of the inner box 102, projection parts 112a and projection-less parts 112b are alternately provided at the same intervals as the hole parts 111a, and projections of the projection parts 112a are inserted into the slots of the hole parts 111a in FIG. 2. Accordingly, the outer box 101 and the inner box 102 are rigidly fixed to one another.

In addition, contrary to the above-described structure, the hole parts 111a and the projection parts 112a may be present in the inner box 102 and the outer box 101, respectively.

Since the outer box 101 and the inner box 102 are rigidly fixed to one another in the above manner, generation of corrugation or warpage of the inner box 102 in the open part 2 is suppressed. Furthermore, the magnet gasket 90 in the door 20 can be brought into contact with the inner box 102 in a flat manner. Additionally, the heat penetration due to uplift of the magnet gasket 90 can also be suppressed.

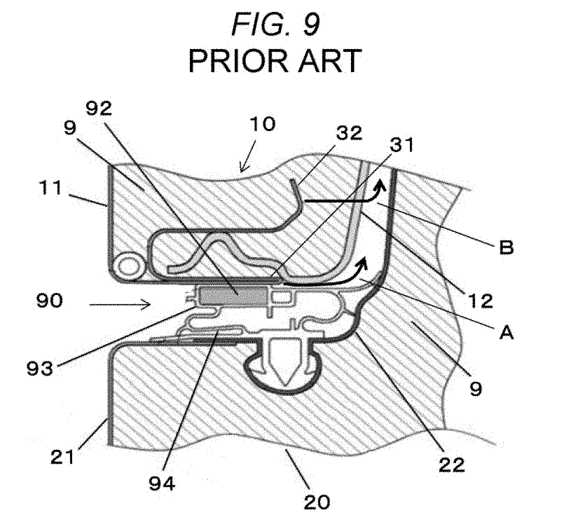

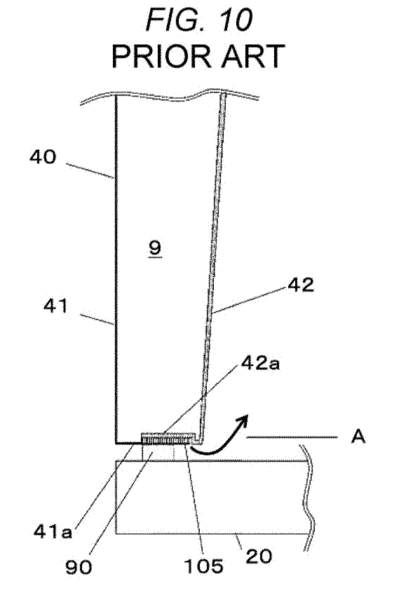

Furthermore, as shown in FIG. 1, the inner-box/outer-box-joint region 111 is located to the outer side of the chamber, and is located outward beyond the door/heat-insulation-box-joint region 112 where the magnetic material 60 and the magnet 92 in the magnet gasket 90 are brought into contact with each other (i.e., located to a place where the outside air is present, namely somewhere around the outer side of the open part 2). In this structure, the magnetic material 60 is placed in the door/heat-insulation-box-joint region 112, and thus, the magnet 92 placed in the magnet gasket 90 in the door 20 is attached onto the magnetic material 60. Closure capability of the heat-insulation box and the door is secured based on attraction between the magnet 92 and the magnetic material 60, and thus, the metal plate of the outer box 101 is exposed on the inside of the chamber, to thereby prevent penetration of the outside heat into the chamber (i.e., it becomes possible to prevent the heat penetration through the pathways referred to as “A” in FIGS. 9 and 10).

A method for producing the refrigerator configured in the above-described manner, and effects of the refrigerator will be described.

### <Placement of the Magnetic Material 60 in the Inner Box 102>

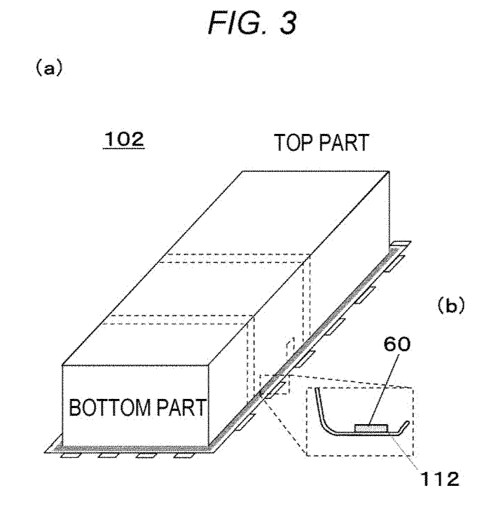

At first, as shown in (a) and (b) in FIG. 3, the magnetic material 60 is placed inside the inner box 102 formed by vacuum molding, based on an adhesion member (not shown in the figures) that may be formed of an adhesive or double-faced adhesive tape.

(a) in FIG. 3 is a perspective view of the inner box 102, and (b) in FIG. 3 is an enlarged sectional view of the door/heat-insulation-box-joint region 112 of the inner box 102.

### <Incorporation of the Inner Box 102 Into the Outer Box 101>

Then, as shown in FIG. 2B, the inner box 102 is turned over. In the inner-box/outer-box-joint region 111 of the outer box 101 shown in FIG. 2A, the multiple hole parts 111a are provided. The multiple projection parts 112a, which are provided in the inner box 102 at the same intervals as the hole parts 111a, are inserted into the multiple hole parts 111a. Accordingly, the inner box 102 is incorporated into the outer box 101.

### <Incorporation of a Bottom Plate 13, and Partition Plates 14a, 14b, 14c and 14d >

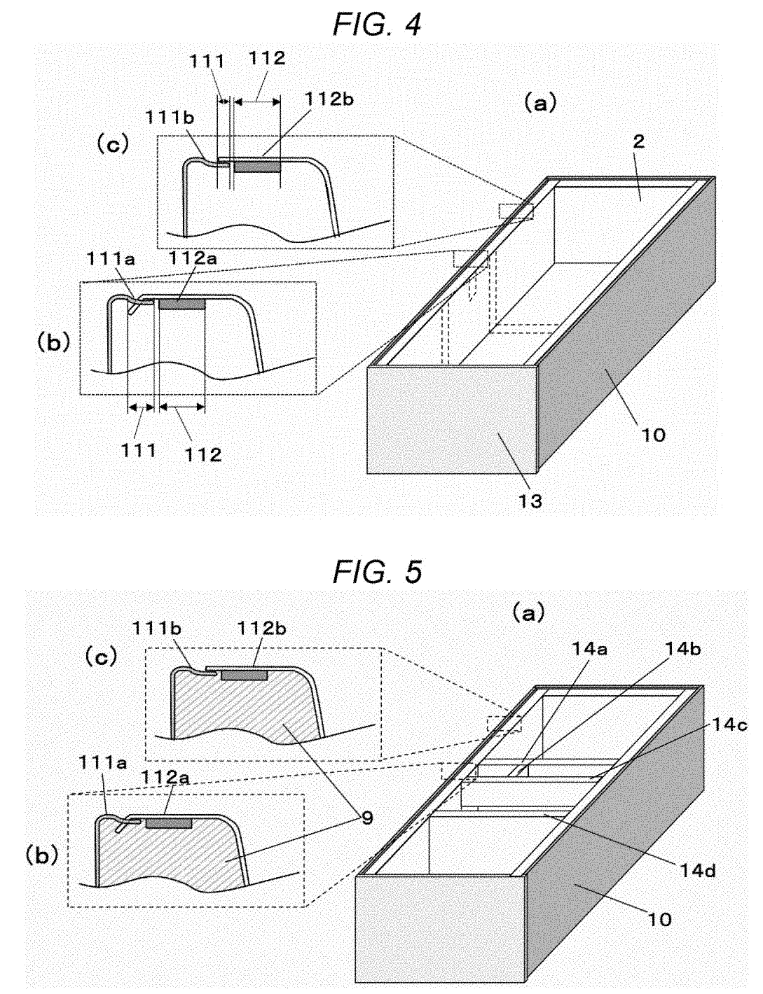

(a) in FIG. 4 is a perspective view of the heat-insulation box 10. (b) and (c) in FIG. 4 are cross-section views of engagement parts between the Inner box 102 and the outer box 101.

As shown in (a) in FIG. 4, a bottom plate 13 is incorporated into the heat-insulation box 10. In this case, structures of the hole parts 111a (projection parts 112a of the door/heat-insulation-box-joint region 112), and hole-less parts 111b (projection-less parts 112b) in the inner-box/outer-box-joint region 111 are shown in (b) and (c) in FIG. 4, respectively.

Then, as shown in (a) in FIG. 5, which is a perspective view of the heat-insulation box 10, partition plates 14a, 14b, 14c and 14d that each separate different-temperature-zone compartments in the refrigerator are incorporated into the heat-insulation box 10.

### <Filling of a Foamable Heat-Insulation Material 9 and Placement of a Backplate>

As shown in (b) and (c) in FIG. 5, which are cross-section views of engagement parts between the inner box 102 and the outer box 101, a foamable heat-insulation material 9 is filled into a space between the inner box 102 and the outer box 101 from the rear of the refrigerator (the backside of the open part 2 of the heat-insulation box). Thus, a heat-insulation box 10 is produced.

A door 20 is attached to the heat-insulation box 10 configured in the above-described manner, thereby producing a refrigerator 1.

### <Effects Brought About by the First Embodiment>

As shown in FIG. 1, the inner-box/outer-box-joint region 111 is located to the outside of the refrigerator, and is located outward beyond the door/heat-insulation-box-joint region 112 where the magnetic material 60 and the magnet 92 in the magnet gasket 90 come into contact with each other (i.e., located to the outside air). In conventional arts, the magnet 92 placed in the magnet gasket 90 had been attached to a metal material of the outer box to thereby secure closure capability of the heat-insulation box and the door. However, in the first embodiment, the magnetic material 60 is provided in the door/heat-insulation-box-joint region 112, and thus, closure capability of the heat-insulation box and the door is secured based on attraction between the magnet 92 and the magnetic material 60. Accordingly, it becomes possible to prevent the metal material of the outer box from being exposed to the outside of the refrigerator, thereby preventing penetration of the outside heat into the refrigerator (i.e., it becomes possible to prevent heat penetration through the pathways referred to by “A” in FIGS. 9 and 10).

In addition, in cases where the inner-box/outer-box-joint region 111 and the door/heat-insulation-box-joint region 112 overlap with each other, the following condition based on the centers of these regions may be required. That is, it may be required that a joint center 71 of the inner box and the outer box is located outward from a joint center 72 of the door and the heat-insulation box (a joint center of the magnet and the magnetic material).

### Second Embodiment

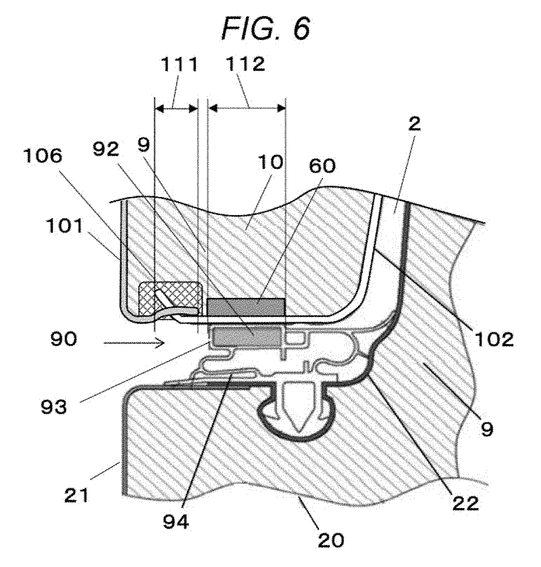

FIG. 6 is an enlarged sectional view of an area around an open part 2 of a heat-insulation box 10 in a refrigerator. In addition, the same elements as those found in the first embodiment will be shown by the same symbols, and detailed descriptions thereon will be omitted. Matters not mentioned in this embodiment would be the same as those described in the first embodiment.

A difference between the first embodiment and the second embodiment is that, as shown in FIG. 6, a gap in the engaging part is filled with an adhesion member 106 that may be formed of an adhesive or resin filler, in the inner-box/outer-box-joint region 111.

Accordingly, corrugation or warpage of the inner box 102 in the open part 2 is suppressed, and also, leakage of the foamable heat-insulation material 9 to the opening 2 when it is filled into the gap can be suppressed.

### Third Embodiment

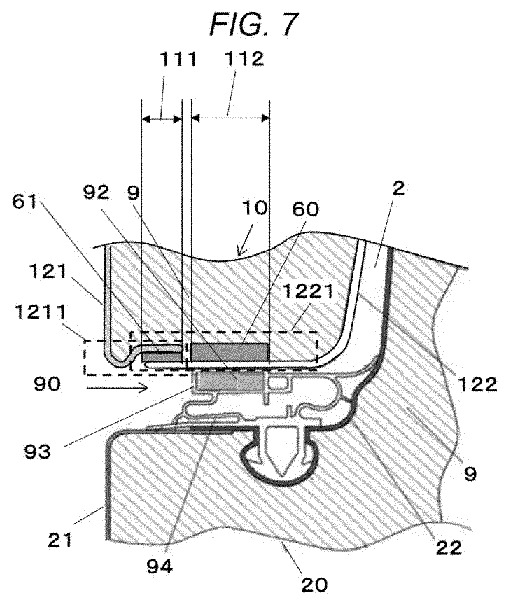

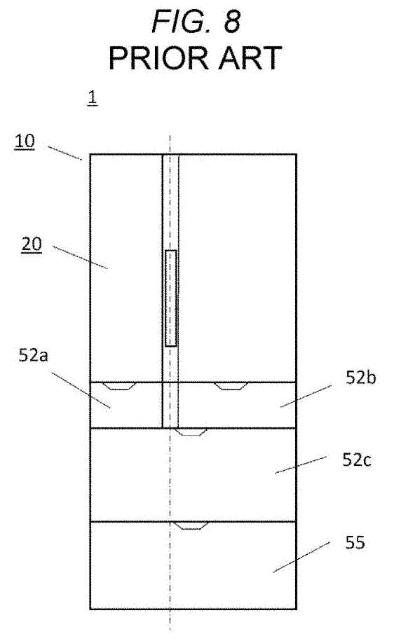

FIG. 7 is an enlarged sectional view of an area around an open part 2 of a heat-insulation box in a refrigerator. In addition, the same elements as those found in the first embodiment will be shown by the same symbols, and detailed descriptions thereon will be omitted. Matters not mentioned in this embodiment would be the same as those described in the first embodiment.

In the third embodiment, the inner-box/outer-box-joint region 111 differs from the corresponding region found in the first embodiment.

A magnetic material 61 is provided and adhered onto an inner box 102 or an outer box 101 in the inner-box/outer-box-joint region 111, with an adhesion member (not shown in the figure) formed by an adhesive or double-faced adhesive tape.

Since the inner-box/outer-box-joint region 111 is rigidly immobilized due to the magnetic force, corrugation or warpage of the inner box in the open part 2 can be suppressed, the inner-box/outer-box-joint region 111 can be brought into contact with a magnet gasket 90 of a door 20 for a refrigeration room, in a flat manner, and thus, heat penetration due to uplift of the magnet gasket 90 can be suppressed.

A refrigerator according to the disclosure can be utilized for the purpose of improving heat insulation performance of various cooling/heating apparatuses (consumer-use and professional-use refrigerators, wine cellars, etc.) that include heat-insulation boxes in which outer boxes made of metal materials (e.g., iron plates) and resin-made inner boxes are engaged with each other, an that further include closing mechanisms based on magnet gaskets.

What is claimed is:

1. A refrigerator, comprising:
a heat-insulation box that has an open part, and a double structure including an outer box and an inner box;
a door that is engaged with the heat-insulation box; and
a gasket that is located between the heat-insulation box and the door, wherein
inner-box/outer-box-joint regions of the outer box and the inner box are located to an outer side of the heat-insulation box, and are located outward beyond door/heat-insulation-box-joint regions of the door and the heat-insulation box that are joined with each other.

2. The refrigerator according to claim 1, wherein the inner-box/outer-box-joining region of the outer box is formed by inwardly folding an edge part of the outer box.

3. The refrigerator according to claim 1, wherein the inner-box/outer-box-joining region of the inner box is formed by inwardly folding an edge part of the inner box.

4. The refrigerator according to claim 1, wherein the door/heat-insulation-box-joint regions are regions in which the gasket is fixed onto the heat insulation box.

5. The refrigerator according to claim 1, wherein the center of the inner-box/outer-box-joint regions is located outward beyond the center of the door/heat-insulation-box-joint regions in the heat-insulation box.

6. The refrigerator according to claim 1, wherein the inner-box/outer-box-joint regions and the door/heat-insulation-box-joint regions do not overlap with each other.

7. The refrigerator according to claim 1, wherein the door/heat-insulation-box-joint regions are regions that can be joined together based on a magnetic material fixed on the heat-insulation box and a magnet placed in the gasket.

8. The refrigerator according to claim 1, wherein the outer box is formed of a metal plate, and the inner box is formed of a resin material.

9. The refrigerator according to claim 1, wherein the inner-box/outer-box-joint regions are parts in which a hole part of the outer box and a projection part of the inner box are engaged with each other, or parts in which a projection part of the outer box and a hole part of the inner box are engaged with each other.

10. The refrigerator according to claim 1, wherein the inner-box/outer-box-joint regions are engaged with each other via a magnetic material.

11. The refrigerator according to claim 1, wherein the inner-box/outer-box-joint regions are covered with an adhesive.
